(19) United States
(12) Patent Application Publication
(10) Pub. No.: US 2012/0031740 A1
(43) Pub. Date: Feb. 9, 2012

(54) ROLLER CONVEYOR FOR TRANSPORTING ITEMS

(76) Inventor: Oliver KAILER, Niedernhausen (DE)

(21) Appl. No.: 13/209,998

(22) Filed: Aug. 15, 2011

Related U.S. Application Data
(63) Continuation of application No. PCT/EP2010/000445, filed on Jan. 28, 2010.

(30) Foreign Application Priority Data
Feb. 13, 2009 (DE) 10 2009 008 938.1

(51) Int. Cl. B65G 13/02; B65G 13/00

(52) U.S. Cl. 198/780; 193/37

(57) ABSTRACT

A roller conveyor for transporting items, in particular items of luggage, is provided. The roller conveyor hays a series of transport rollers which are arranged at a distance from each other in an axially parallel manner and at each of the two ends thereof are mounted on lateral longitudinal carriers of a frame that extend in the direction of transport, wherein a textile web, which extends parallel to the transport surface and is fastened to the frame on its two longitudinal sides, is arranged directly below the transport rollers.

This nonprovisional application is a continuation of International Application No. PCT/EP2010/000445, which was filed on Jan. 28, 2010, and which claims priority to German Patent Application No. DE 10 2009 008 938.1, which was filed in Germany on Feb. 13, 2009, and which are both herein incorporated by reference.

### BACKGROUND OF THE INVENTION

1. Field of the Invention

The invention relates to a roller conveyor for transporting items, in particular items of luggage, the roller conveyor includes a series of transport rollers which are arranged at a distance from each other in an axially parallel manner. At each of the two ends thereof the transport rollers are mounted on lateral longitudinal carriers of a frame that extend in the direction of transport.

2. Description of the Background Art

These types of roller conveyors are used in a known manner in many cases at control stations, for example passenger control stations in airports, for conveying items such as items of luggage through testing devices.

Disadvantages of the roller conveyors usually used are that small items can fall through between the transport rollers and that the mechanical systems that are arranged below the roller conveyor can be seen between the transport rollers. This latter is undesirable in particular in places that are frequented by the public.

In order to avoid these disadvantages, it is known to provide fixed facings on the underside of the roller conveyors, for example made from metal or plastics material. However, this results in the following disadvantages: the fixed metal or plastics material plates necessary for this purpose are mechanically difficult to install and fasten; the large areas of facing can generate vibrations and resonances, amplifying the mechanical running noises; or if an item falls through between the rollers and somebody tries to reach for it, there is a risk of injury if they move their hand between a transport roller and the facing. This risk is particularly great if the transport roller is being driven.

### SUMMARY OF THE INVENTION

It is therefore an object of the invention to create a roller conveyor that does not have the aforementioned disadvantages.

This object is achieved in an embodiment in that a textile web, which extends parallel to the transport surface and is fastened to the frame on its two longitudinal sides, is arranged directly below the transport rollers.

The fastening of the textile web is preferably effected by a combination of edge reinforcement and edge reinforcement rail. To this end, an edge reinforcement rail is fastened at least to one lateral longitudinal carrier, preferably to both longitudinal carriers, of the frame. The textile web has corresponding lateral edge reinforcements that in each case are guided in an edge reinforcement rail. The textile web is preferably elastically resilient. This means that it can also be installed at a low cost in places that are difficult to access and forms additional noise reduction and vibration damping.

If the textile web is developed in a reticulate manner, it obtains greater mechanical flexibility. A closed textile web or a reticulate textile web with a small mesh size prevents the mechanical systems arranged below from being seen. In addition, a textile web of this kind can be printed on and thus is able to be utilized for information and advertising purposes. The textile material is able to yield due to the elastic flexibility thereof if a person reaches through between the transport rollers and their hand gets between the textile web and the transport rollers. This consequently rules out any risk of injury.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a roller conveyor from above; and

FIG. 2 shows a perspective view of a roller conveyor from below.

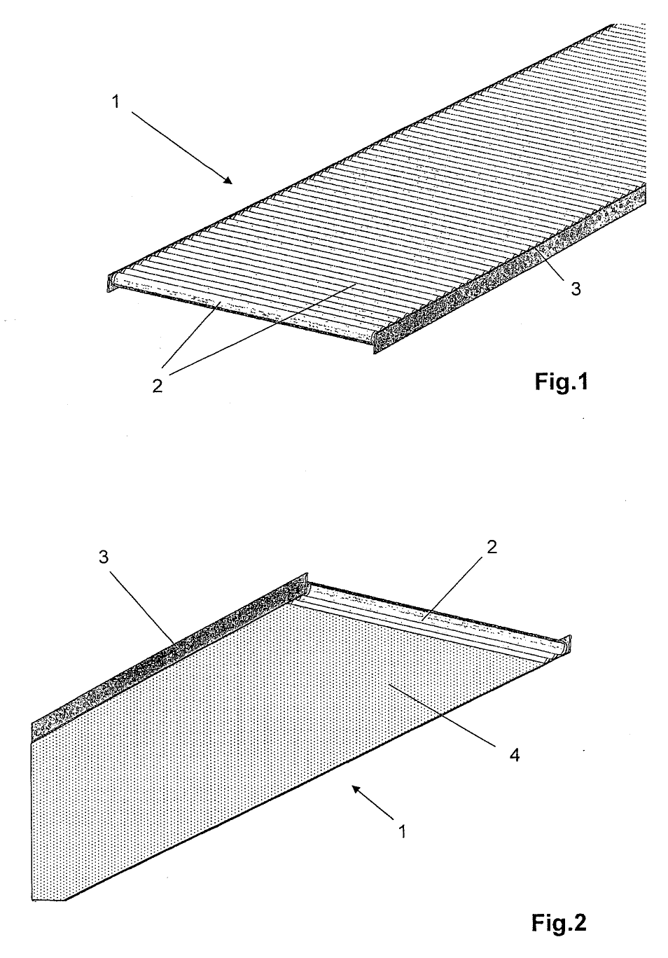

### DETAILED DESCRIPTION

The roller conveyor 1 is a component of a control station for checking items, in particular items of luggage, said control station including an X-ray testing device as testing device. These types of control stations are used in airports in order to check the passengers' luggage for illegal objects. The items, in the example items of luggage, are supplied to the testing device and/or are guided away from said testing device after the testing by means of the roller conveyor 1.

The roller conveyor 1 comprises a series of transport rollers 2 which are arranged at a small distance from each other in an axially parallel manner and at each of the two ends thereof are mounted on lateral longitudinal carriers 3 of a frame that extend in the direction of transport.

At least some, in the case of simple applications all the transport rollers 2 are mounted so as to be free-wheeling. For automatic transport of the items of luggage, individual or several transport rollers 2 can also be connected to a rotational drive.

A textile web 4, which extends parallel to the transport surface and is fastened to the frame on both longitudinal sides, is arranged directly below the transport rollers 2. As can be seen in FIG. 2, the textile web is fastened to the longitudinal carriers 3 of the frame on both sides.

The fastening of the textile web 4 to the frame is can be effected through a combination of edge reinforcement and edge reinforcement rail. To this end, in each case an edge reinforcement rail is fastened to at least one lateral longitudinal carrier 3, preferably to both longitudinal carriers 3, of the frame, and the textile web 4 includes an edge reinforcement at least on one longitudinal side, preferably on both longitudinal sides, said edge reinforcement being inserted into the associated edge reinforcement rail. The textile web 4 can be fastened to the frame and also released again from said frame in a simple manner by means of the connection between the edge reinforcement rail and the edge reinforcement.

The textile web 4 can be produced from an elastically resilient material that yields if a person reaches through between the transport rollers 2. If greater mechanical flexibility is necessary, the textile web 4 is produced from a reticulate material. If the textile web 4 is closed or reticulate with a small mesh size, in an advantageous manner it can be printed on and thus is able to be utilized for information and advertising purposes. The flexibility of the textile material makes it possible to install the textile web 4 as facing at a low cost even in places that are difficult to access. In addition, it also acts to reduce noise and dampen vibrations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A roller conveyor for transporting items, in particular items of luggage, the roller conveyor comprising:
a series of transport rollers that are arranged at a distance from each other in an axially parallel manner and at each of two ends thereof are mounted on lateral longitudinal carriers of a frame that extend in the direction of transport; and
a textile web, which extends parallel to the transport surface and is fastened to the frame on its two longitudinal sides, is arranged directly below the transport rollers.

2. The roller conveyor as claimed in claim 1, wherein at least some of the transport rollers are mounted so as to be free-wheeling.

3. The roller conveyor as claimed in claim 1, wherein an edge reinforcement rail is fastened to at least one lateral longitudinal carrier of the frame, and wherein the textile web includes at least one lateral edge reinforcement that is inserted in the edge reinforcement rail.

4. The roller conveyor as claimed in claim 3, wherein the edge reinforcement rail is fastened to each of the two longitudinal carriers and wherein the textile web includes edge reinforcement on both longitudinal sides.

5. The roller conveyor as claimed in claim 1, wherein the textile web is elastically resilient.

6. The roller conveyor as claimed in claim 5, wherein the textile web is developed in a reticulated manner.

7. A control station for checking items, in particular items of luggage, the control station comprising a testing device and at least one roller conveyor, via which the items are supplied to the testing device or are guided away from the testing device, wherein the roller conveyor is the roller conveyor as claimed in claim 1.
